(19) United States
(12) Patent Application Publication
(10) Pub. No.: US 2019/0263297 A1
(43) Pub. Date: Aug. 29, 2019

(54) HEAD SUPPORT FOR A CHILD CAR SEAT AND METHOD

(71) Applicant: FRANCIS KEALOHA, MAKAWAO, HI (US)

(72) Inventor: FRANCIS KEALOHA, MAKAWAO, HI (US)

(21) Appl. No.: 15/905,763

(22) Filed: Feb. 26, 2018

(51) Int. Cl. B60N 2/28; B60N 2/885; B60R 22/00; B60R 22/10

(52) U.S. Cl. CPC B60N 2/2851; B60R 22/105; B60R 22/001; B60N 2/885

(57) ABSTRACT

A head support for a child car seat is disclosed. The head support includes a left pad configured to support a neck and head of the child from the left side, a right pad configured to support the neck and head of the child from the right side, a front-closure configured to removably couple the left pad to the right pad on the front, a rear-closure configured to removably couple the left pad to the right pad on the back, opposite the front closure and about the neck of the child, a car seat mount affixable to the child car-seat, and configured to couple the head support to the child car seat, and a pair of collar-straps configured to couple the left pad and the right pad to the car seat mount, respectively.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of headrests of existing art and more specifically relates to headrests for children.

### RELATED ART

A “car seat” (infant safety seat, child restraint system, child seat, baby seat, restraining car seat, etc.) is a seat designed to protect younger children from injury or death during car travel collisions and to restrain the child during car travel. Most car seats include head and neck protection in case of a car accident. Car seats are required in most cases, depending upon the child's age, by law.

However, car seats do not provide head and/or neck support in a forward direction for a child that may fall asleep or a child that does not have the neck strength to support one's own head. Therefore a suitable solution is desired.

U.S. Pat. No. 7,252,330 to Meagan D. Lincoln relates to a children's car seat pillow. The described children's car seat pillow includes children's pillow adapted for use with a children's car seat comprising: a central area adapted to receive at least a rearward portion of a child's head; a first lateral wing extending from the central area; a second lateral wing extending from the central area; a neck support region; and a retainer adapted to mount the children's pillow to the children's car seat, where the neck support region extends between the first lateral wing and the second lateral wing.

### SUMMARY OF THE INVENTION

In view of the foregoing disadvantages inherent in the known headrests with seat attachment for children's seat art, the present disclosure provides a novel head support for a child car seat and method. The general purpose of the present disclosure, which will be described subsequently in greater detail, is to provide a head support for a child car seat and method.

A head support for a child car seat is disclosed herein. The head support including a left pad configured to support a neck and head of the child from the left side; a right pad configured to support the neck and head of the child from the right side; a front-closure configured to removably couple the left pad to the right pad on the front; a rear-closure configured to removably couple the left pad to the right pad on the back, opposite the front closure and about the neck of the child; a car seat mount affixable to the child car-seat, and configured to couple the head support to the child car seat; and a pair of collar-straps configured to couple the left pad and the right pad to the car seat mount, respectively. According to another embodiment, a method of using a head support for a child car seat is also disclosed herein. The method includes providing the head support as described above; affixing the head support to the child car seat; adjusting the head support to accommodate a head size of the child; placing the child in the child car-seat; and placing the head support about the neck of the child.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a head support for a child car seat, constructed and operative according to the teachings of the present disclosure.

FIG. 1 is a perspective view of the head support for a child car seat during an ‘in-use’ condition, according to an embodiment of the disclosure.

FIG. 2 is a perspective view of the head support for a child car seat of FIG. 1 in isolation, according to an embodiment of the present disclosure.

FIG. 3 is a perspective view of the head support for a child car seat showing an alternate attachment, according to another embodiment of the present disclosure.

FIG. 4 is a perspective view of the head support for a child car seat showing an underside of the head support for a child, according to an embodiment of the present disclosure.

FIG. 5 is a flow diagram illustrating a method of using a head support for a child car seat, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a headrests with seat attachment for children's seat and more particularly to a head support for a child car seat and method as used to improve the stability of a child's neck and head while using a car seat.

Generally, the novel head support for a child car seat is designed to be a stand-alone attachment that can be used with all makes and models of car safety seats. It will wrap gently around the child's head and provides twin cushions to provide the best angle for the child's rest and comfort. The positions of the twin cushions can be adjusted by lengthening or shortening the straps that connect the cushions to the car seat, which also slip through the slots provided for the shoulder belts.

There is an adjustable (e.g., hook-and-loop, buttons, snaps, etc.) strap joining the two cushions, which can be extended as the child grows bigger. The cushions themselves may be made from a memory foam material. There may be patches attached to the shoulder belts of the safety seat in order to keep the cushions in a secure position around the child's neck.

For example, aspects of the head support may include a front, a back, a left side, and a right side relative to a seated child. The left pad is configured to support the neck and head of the child from the left side, and the right pad is configured to support the neck and head of the child from the right side. The left pad and the right pad are further configured to interface with, and support, a jaw of the child from the left side and the right side, respectively.

The front-closure is configured to removably couple the left pad to the right pad on the front, and the rear-closure is configured to removably couple the left pad to the right pad on the back, opposite the front closure and about the neck of the child. Included is a car seat mount affixable to the child car-seat, configured to couple the head support to the child car seat. Also included is a pair of collar-straps configured to couple the left pad and the right pad to the car seat mount, respectively. At least one of the car seat mount and the pair of collar-straps are adjustable. The car seat mount includes a collar-strap fastener configured to removably couple with the pair of collar-straps.

Also, the pair of collar-straps includes at least one attachment-fastener configured to removably couple the left pad and the right pad to the car seat mount with the attachment-fastener including at least one of a hook-and-loop fastener, a plurality of buttons, a plurality of twist-studs, or a plurality of clips.

Additionally, the car seat mount includes a pair of adjustable seat-straps, each seat-strap including at least one adjustment-fastener, with the adjustment-fastener configured to adjust a length of the respective seat-strap. The adjustment-fastener of each of the seat-straps includes at least one of a hook-and-loop fastener, a plurality of buttons, and a plurality of twist-studs.

The pair of adjustable seat-straps is preferably constructed from an elastic material. Also, the neck-support is preferably made of flame-resistant materials and anti-fungal materials. Also, collar-straps are constructed from an elastic material.

The front-closure includes a hook-and-loop fastener configured to provide adjustability in fit to the front-closure. Similarly, rear-closure includes a hook-and-loop fastener configured to provide adjustability in fit to the rear-closure. Each of the left pad and the right pad include a memory-foam core. The bottom side of each the left pad and right pad each include a textured surface to improve traction.

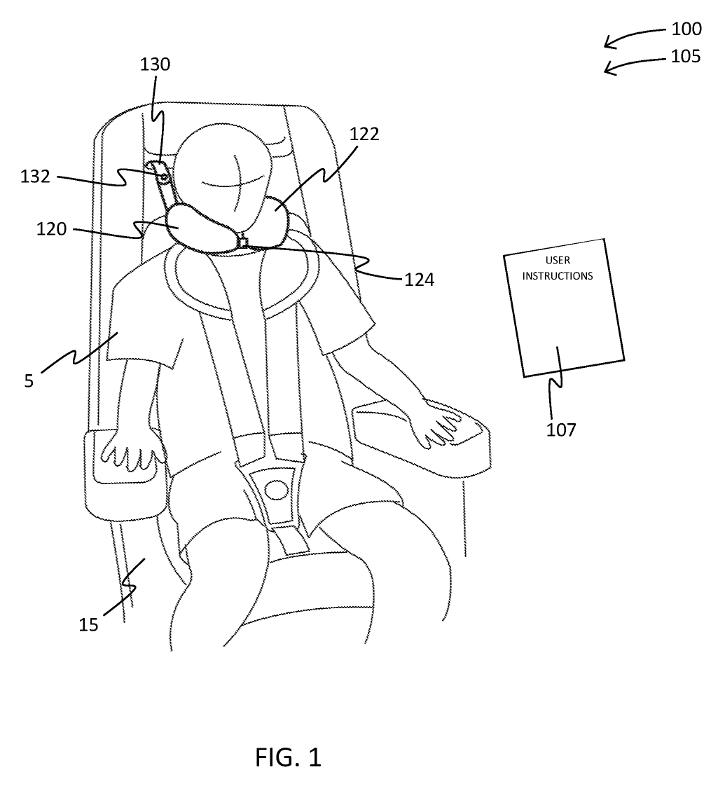

Referring now more specifically to the drawings by numerals of reference, there is shown in FIGS. 1-4, various views of a head support for a child car seat 100.

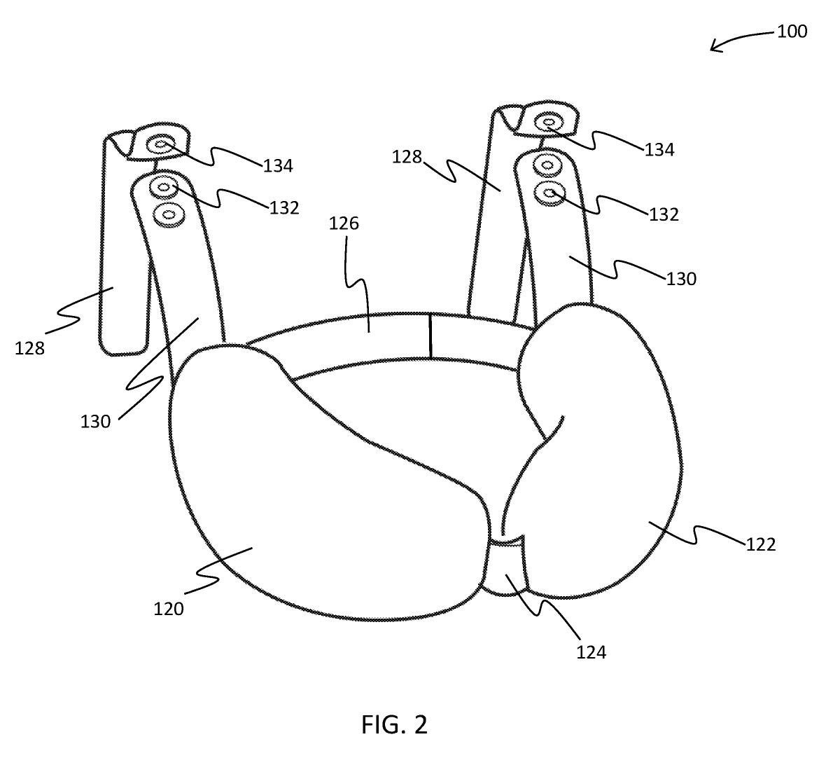

FIG. 1 is a perspective view of a head support 100 for a child car seat 15 during an ‘in-use’ condition 50, according to an embodiment of the present disclosure. Here, head support for a child car seat 100 may be beneficial to provide increased neck and head support to a seated child 5. As illustrated, the head support 100 may include a left pad 120, a right pad 122, a front-closure 124, a rear-closure 126 (FIG. 2), a car seat mount 128, and a pair of collar-straps 130.

According to one embodiment, the head support for a child car seat 100 may be arranged as a kit 105. In particular, the head support 100 may further include a set of instructions 107. The instructions 107 may detail functional relationships in relation to the structure of the head support 100 such that the head support 100 can be used, maintained, or the like, in a preferred manner.

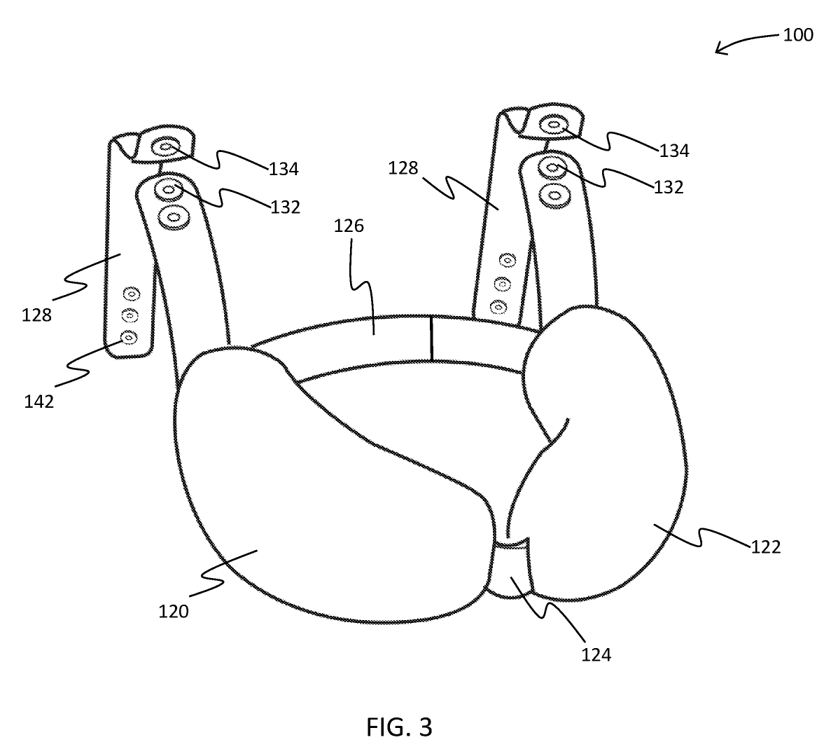

FIG. 2 is a perspective view of the head support for a child car seat of FIG. 1 in isolation, according to an embodiment of the present disclosure. FIG. 3 is a perspective view of the head support for a child car seat showing an alternate attachment, according to another embodiment of the present disclosure. As above and now referring to FIGS. 2-3, the head support 100 for a child car seat may include the left pad 120, the right pad 122, the front-closure 124, the rear-closure 126, the car seat mount 128, and the pair of collar-straps 130. At least one of the car seat mount 128 and the pair of collar-straps 130 may be adjustable.

The left pad 120 may be configured to support a neck and head of the child 5 (FIG. 1) from the left side, and similarly, the right pad 122 may be configured to support the neck and head of the child 5 from the right side. Also, left pad 120 and right pad 122 may be further configured to interface with and support a jaw of the child 5 from the left side and the right side, respectively.

Front-closure 124 may be configured to removably couple left pad 120 to right pad 122 on the front. Also, rear-closure 126 may be configured to removably couple left pad 120 to right pad 122 on the back, opposite front-closure 124 and about the neck of the child. Car seat mount 128 may be affixable to a child car-seat 15 (FIG. 1), and configured to couple head support 100 to the child car-seat 15. The pair of collar-straps 130 may be configured to couple left pad 120 and right pad 122 to car seat mount 128, respectively.

Car seat mount 128 may include collar-strap fastener 132 configured to removably couple with the pair of collar-straps 130, where the pair of collar-straps 130 may be adjustable in length. Additionally, the pair of collar-straps 130 may include at least one attachment-fastener 134 configured to removably couple left pad 120 and right pad 122 to car seat mount 128. Attachment-fastener 134 may include at least one of a hook-and-loop fastener, a plurality of buttons, a plurality of twist-studs, and a plurality of clips.

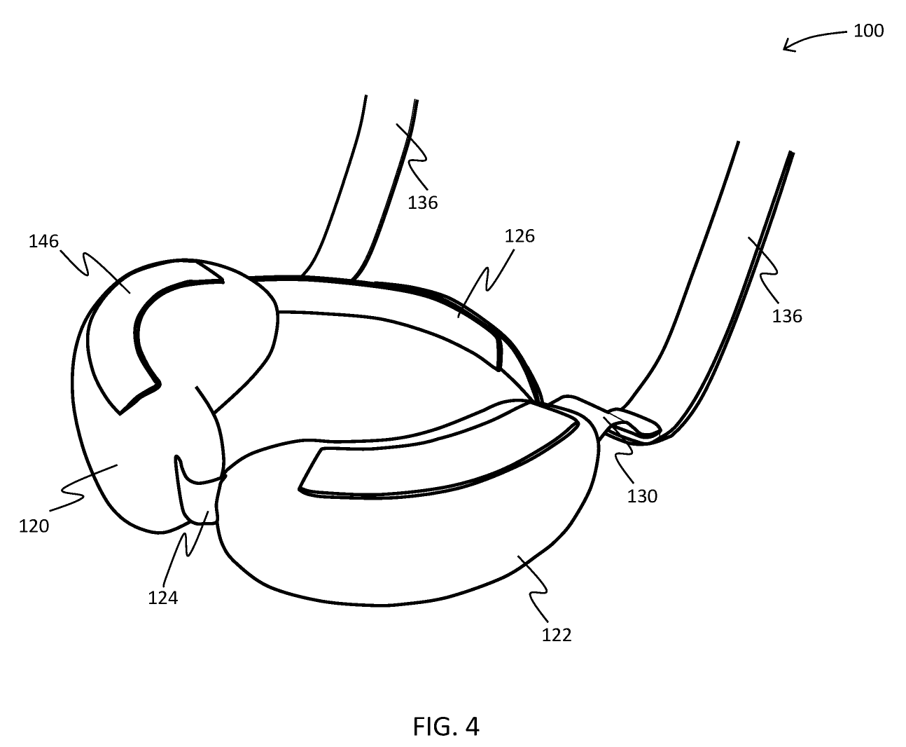

FIG. 4 is a perspective view of the head support for a child car seat showing an underside of the head support for a child according to yet another embodiment of the present disclosure. Each of left pad 120 and right pad 122 may include a memory-foam core. Further, the bottom side of left pad 120 and right pad 122 may each include a textured surface.

According to one embodiment, the car seat mount 128 (FIG. 3) may also include pair of adjustable seat-straps 136. In particular, each seat-strap 136 may include at least one adjustment-fastener (not shown), with adjustment-fastener configured to adjust a length of the respective seat-strap 136. The adjustment-fastener of each of the seat-straps 136 may include at least one of a hook-and-loop fastener, a plurality of buttons, and a plurality of twist-studs.

The pair of adjustable seat-straps 136 may be constructed from an elastic material, and the left pad 120 and right pad 122 may be made of flame-resistant materials. Also, head support 100 may be made of anti-fungal materials and pair of collar-straps 130 may be constructed from an elastic material.

Front-closure 124 may include a hook-and-loop fastener configured to provide adjustability in fit to the front-closure 124, and rear-closure 126 may also include a hook-and-loop fastener configured to provide adjustability in fit to the rear-closure 126.

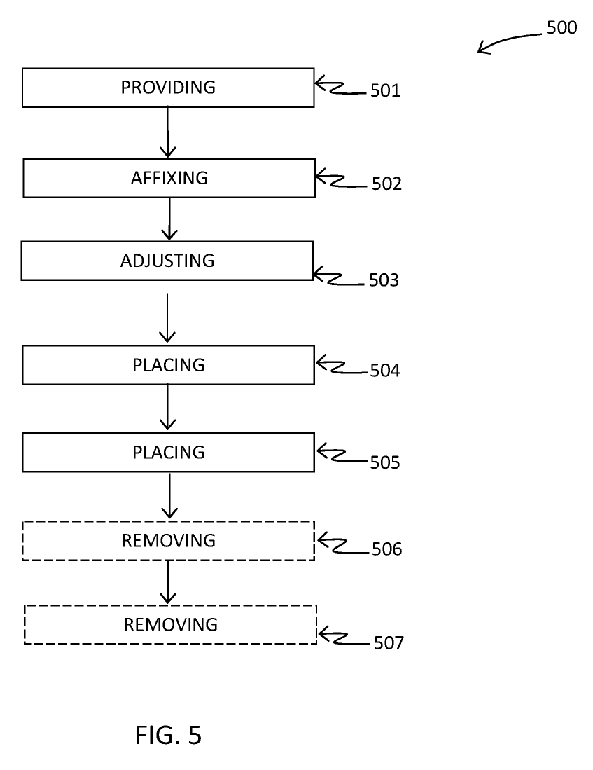

FIG. 5 is a flow diagram illustrating a method of using a head support for a child car seat, according to an embodiment of the present disclosure. In particular, method 500 of using head support for a child car seat may include one or more components or features of the head support 100 for a child car seat as described above. As illustrated, the method 500 of using head support for a child car seat includes step one 501, providing a head support 100 for a child car seat, the head support 100 including the left pad 120, the right pad 122, the front-closure 124, the rear-closure 126, the car seat mount 128, and pair of collar straps 130; step two 502, affixing the head support 100 to the child car-seat 15; step three 503, adjusting the head support 100 to accommodate the particular size of the child 5; step four 504, placing the child 5 in the child car-seat 15; step five 505, and placing the head support 100 on the neck of the child 5. The method 500 may further include step six 506, removing head support 100 from the neck of the child 5; and step seven 507, removing the head support 100 from the child's car-seat 15.

It should be noted that step six 506 and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a child restraining car seat device [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A head support for a child car seat, the child car seat defining a front, a back, a left side, and a right side relative to a seated child, the head support comprising:
a left pad configured to support a neck and head of the child from the left side;
a right pad configured to support the neck and head of the child from the right side;
a front-closure configured to removably couple the left pad to the right pad on the front;
a rear-closure configured to removably couple the left pad to the right pad on the back, opposite the front closure and about the neck of the child;
a car seat mount affixable to the child car-seat, and configured to couple the head support to the child car seat; and
a pair of collar-straps configured to couple the left pad and the right pad to the car seat mount, respectively.

2. The head support of claim 1, wherein at least one of the car seat mount and the pair of collar-straps is adjustable.

3. The head support of claim 1, wherein the car seat mount includes a pair of collar-strap fasteners configured to removably couple with the pair of collar-straps; and
wherein the pair of collar-straps are adjustable in length.

4. The head support of claim 1, wherein the left pad and the right pad are further configured to interface with and support a jaw of the child from the left side and the right side, respectively.

5. The head support of claim 1, wherein the pair of collar-straps includes at least one attachment-fastener configured to removably couple the left pad and the right pad to the car seat mount.

6. The head support of claim 5, wherein the attachment-fastener includes at least one of a hook-and-loop fastener, a plurality of buttons, a plurality of twist-studs, and a plurality of clips.

7. The head support of claim 1, wherein the car seat mount includes a pair of adjustable seat-straps, each seat-strap including at least one adjustment-fastener, said adjustment-fastener configured to adjust a length of the respective seat-strap.

8. The head support of claim 7, wherein the adjustment-fastener of each of the seat-straps includes at least one of a hook-and-loop fastener, a plurality of buttons, and a plurality of twist-studs.

9. The head support of claim 7, wherein the pair of adjustable seat-straps are constructed from an elastic material.

10. The head support of claim 1, wherein the left pad and the right pad are made of flame-resistant materials.

11. The head support of claim 1, wherein the left pad and the right pad are made of anti-fungal materials.

12. The head support of claim 1, wherein the pair of collar-straps are constructed from an elastic material.

13. The head support of claim 1, wherein the front-closure includes a hook-and-loop fastener configured to provide adjustability in fit to the front-closure.

14. The head support of claim 1, wherein the rear-closure includes a hook-and-loop fastener configured to provide adjustability in fit to the rear-closure.

15. The head support of claim 1, wherein each of the left pad and the right pad include a memory-foam core.

16. The head support of claim 1, wherein a bottom side of the left pad and right pad each includes a textured surface.

17. A head support for a child car seat, the child car seat defining a front, a back, a left side, and a right side relative to a seated child, the head support comprising:
a left pad configured to support a neck and head of the child from the left side;
a right pad configured to support the neck and head of the child from the right side
a front-closure configured to removably couple the left pad to the right pad on the front;
a rear-closure configured to removably couple the left pad to the right pad on the back, opposite the front closure and about the neck of the child;
a car seat mount affixable to the child car-seat, and configured to couple the head support to the child car seat; and
a pair of collar-straps configured to couple the left pad and the right pad to the car seat mount, respectively; and
wherein at least one of the car seat mount and the pair of collar-straps is adjustable;
wherein the car seat mount includes a pair of collar-strap fasteners configured to each removably couple with the pair of collar-straps;
wherein the pair of collar-straps are adjustable in length;
wherein the left pad and the right pad are further configured to interface with and support a jaw of the child from the left side and the right side, respectively;
wherein the pair of collar-straps includes at least one first attachment-fastener configured to removably couple the left pad and the right pad to the car seat mount;
wherein the first attachment-fastener includes at least one of a hook-and-loop fastener, a plurality of buttons, a plurality of twist-studs, and a plurality of clips;
wherein the car seat mount includes a pair of adjustable seat-straps, each adjustable seat-strap including at least one second adjustment-fastener, said second adjustment-fastener configured to adjust a length of the respective adjustable seat-strap;
wherein the second adjustment-fastener of each of the pair of adjustable seat-straps includes at least one of a hook-and-loop fastener, a plurality of buttons, and a plurality of twist-studs;
wherein the pair of adjustable seat-straps are constructed from an elastic material;
wherein the left pad and the right pad are made of flame-resistant materials;
wherein the left pad and the right pad are made of anti-fungal materials;
wherein the pair of collar-straps are constructed from an elastic material;
wherein the front-closure includes a hook-and-loop fastener configured to provide adjustability in fit to the front-closure;
wherein the rear-closure includes a hook-and-loop fastener configured to provide adjustability in fit to the rear-closure; and
wherein each of the left pad and the right pad include a memory-foam core.

18. The head support of claim 17, further comprising set of instructions; and
wherein the head support is arranged as a kit.

19. A method of supporting a head of a child in a child car seat, the child car seat defining a front, a back, a left side, and a right side relative to the child when seated in said car seat, the method comprising the steps of:
providing a head support including
a left pad configured to support a neck and head of the child from the left side,
a right pad configured to support the neck and head of the child from the right side,
a front-closure configured to removably couple the left pad to the right pad on the front,
a rear-closure configured to removably couple the left pad to the right pad on the back, opposite the front closure and about the neck of the child,
a car seat mount affixable to the child car-seat, and configured to couple the head support to the child car seat, and
a pair of collar-straps configured to couple the left pad and the right pad to the car seat mount, respectively;
affixing the head support to the child car seat;
adjusting the head support to accommodate a head size of the child;
placing the child in the child car-seat; and
placing the head support about the neck of the child.

20. The method of claim 19, further comprising the steps of:
removing the head support from about the neck of the child; and
removing the head support from the child car-seat.
